(19) United States
(12) Patent Application Publication
(10) Pub. No.: US 2015/0264750 A1
(43) Pub. Date: Sep. 17, 2015

(54) MAGNETIC FLUID HEATING APPARATUS

(71) Applicant: JOE WALDNER, Clark, SD (US)

(72) Inventor: JOE WALDNER, Clark, SD (US)

(21) Appl. No.: 14/203,644

(22) Filed: Mar. 11, 2014

(51) Int. Cl. H05B 6/10

(52) U.S. Cl. CPC H05B 6/108; H05B 6/109

(57) ABSTRACT

An apparatus for heating fluid may comprise a housing with an interior, a fluid inlet, and a fluid outlet. A fluid heating assembly in the housing is rotatable and includes a plurality of disks including a conductive material and being spaced from each other to form gaps therebetween. A magnetic assembly may be configured to apply a magnetic field of adjustable intensity to the disks. The magnetic assembly may comprise a plurality of magnetic elements positioned adjacent to the disks and a support structure supporting the magnetic elements proximate to the gaps between the disks. The support structure moves the magnetic elements between a maximum exposure position with respect to the conductive material of the disks in which a relatively greater degree of heating is produced and a minimum exposure position with respect to the conductive material in which a relatively lesser degree of heating is produced.

### BACKGROUND

### Field

The present disclosure relates to fluid heating apparatus and more particularly pertains to a new magnetic fluid heating apparatus.

### SUMMARY

In one aspect, the present disclosure relates to an apparatus for heating fluid. The apparatus may comprise a housing defining an interior, with the housing having a fluid inlet into the interior and a fluid outlet out of the interior. The apparatus may also include a fluid heating assembly positioned in the housing to heat fluid entering the interior, with the heating assembly being rotatable with respect to the housing about an axis of rotation. The fluid heating assembly may comprise a support shaft and a plurality of disks mounted on the support shaft and being oriented substantially perpendicular to the axis of rotation of the impeller assembly, with the plurality of disks being positioned along the support shaft and being spaced from each other in an axial direction to form gaps therebetween. The disks may include a conductive material. The apparatus may also include a magnetic assembly configured to apply a magnetic field of adjustable intensity to the disks, with the magnetic assembly being positioned in the interior of the housing. The magnetic assembly may comprise a plurality of magnetic elements positioned adjacent to the disks, and a support structure supporting the plurality of magnetic elements proximate to the gaps between the disks. The support structure may move the magnetic elements between a maximum exposure position with respect to the conductive material of the disks in which a relatively greater degree of heating is produced and a minimum exposure position with respect to the conductive material of the disks in which a relatively lesser degree of heating is produced.

There has thus been outlined, rather broadly, some of the more important elements of the invention in order that the detailed description thereof that follows may be better understood, and in order that the present contribution to the art may be better appreciated. There are additional elements of the invention that will be described hereinafter and which will form the subject matter of the claims appended hereto.

In this respect, before explaining at least one embodiment or implementation in greater detail, it is to be understood that the scope of the invention is not limited in its application to the details of construction and to the arrangements of the components, and the particulars of the steps, set forth in the following description or illustrated in the drawings. The invention is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present invention.

The advantages of the various embodiments of the present invention, along with the various features of novelty that characterize the invention, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic perspective view of one embodiment of a new magnetic fluid heating apparatus according to the present disclosure.

FIG. 2 is a schematic perspective view of the apparatus of the illustrative embodiment with the top wall removed to reveal details in the interior of the housing.

FIG. 3 is a schematic perspective view of the apparatus of the illustrative embodiment from an alternate angle with the top wall removed to reveal details in the interior of the housing.

FIG. 4 is a schematic perspective sectional view of the apparatus of the illustrative embodiment.

FIG. 5 is a schematic side sectional view of the impeller assembly of the illustrative embodiment.

### DETAILED DESCRIPTION

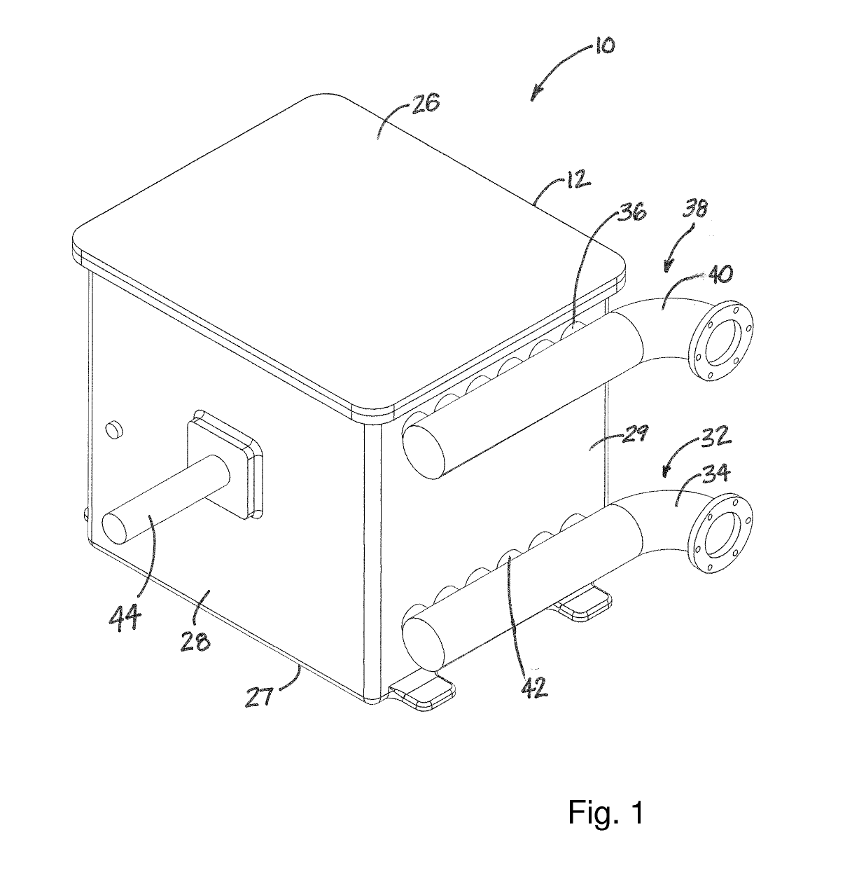

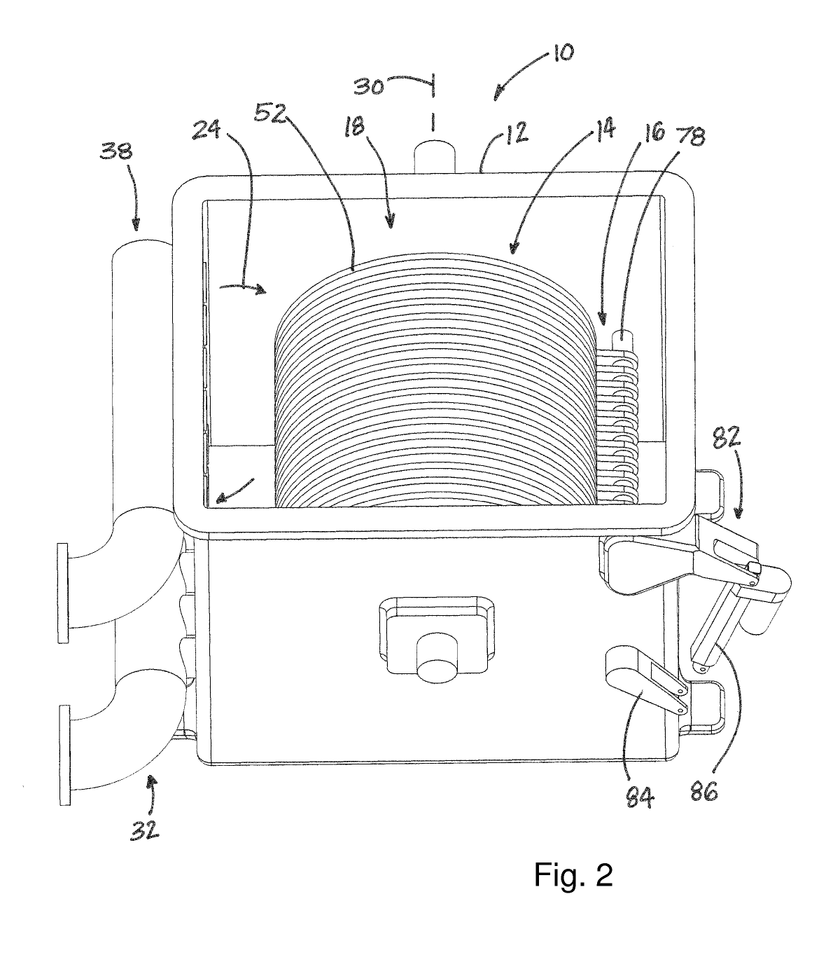

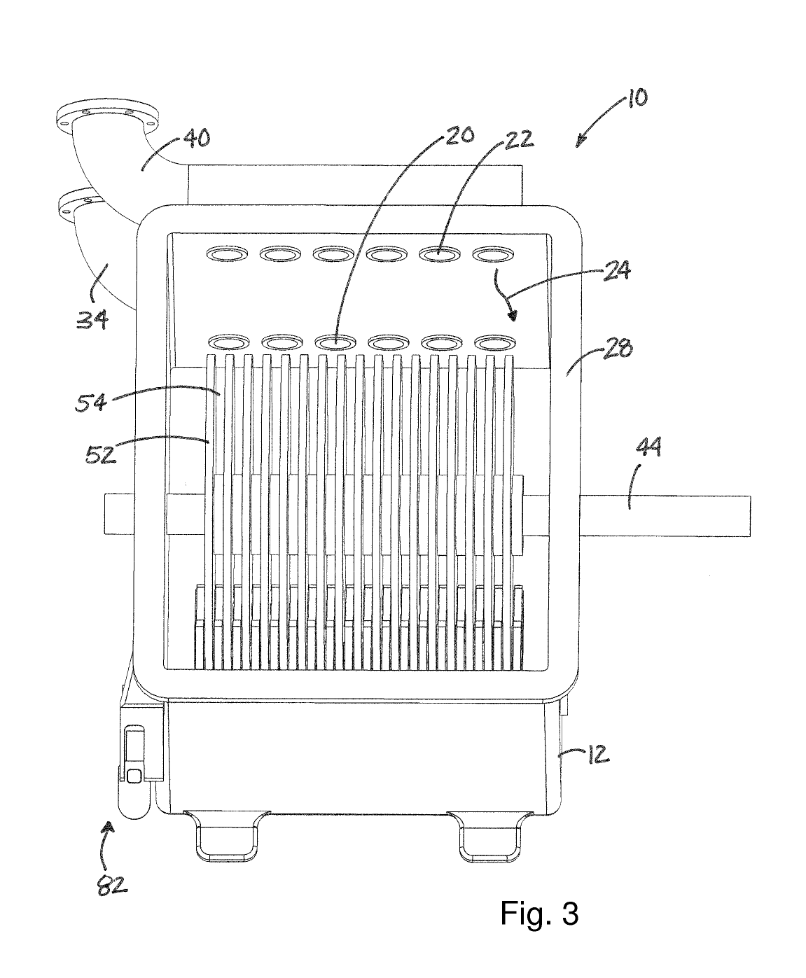

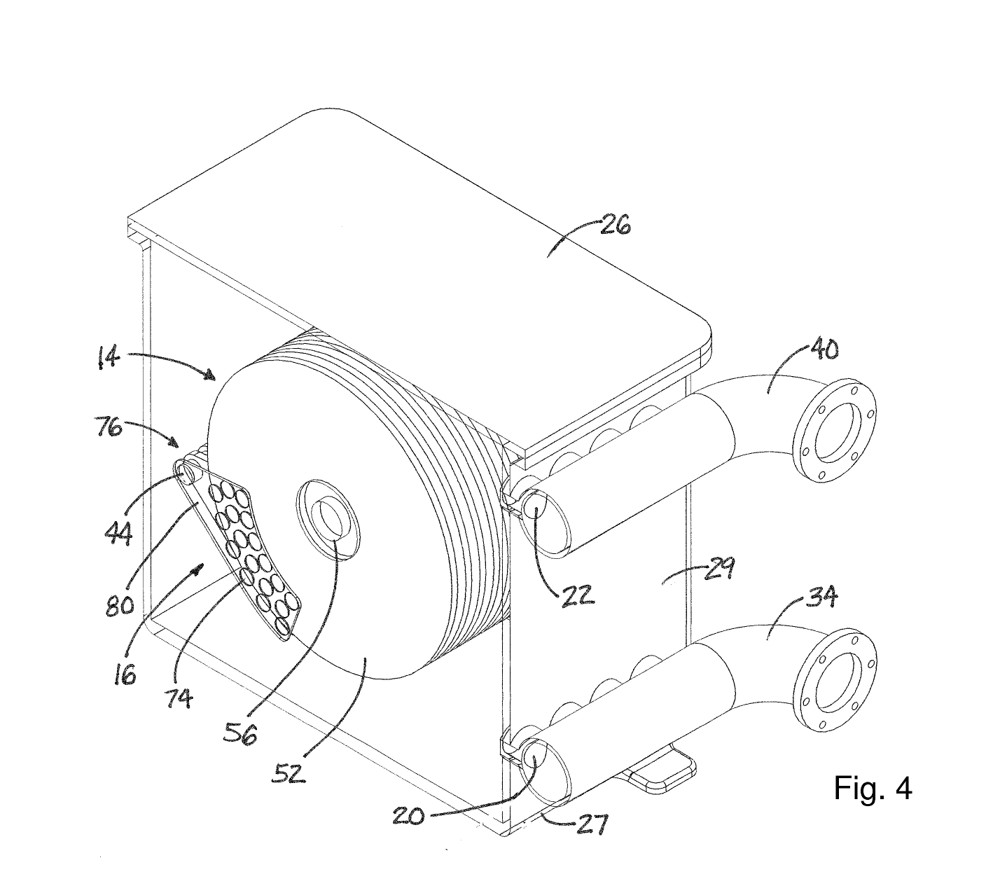

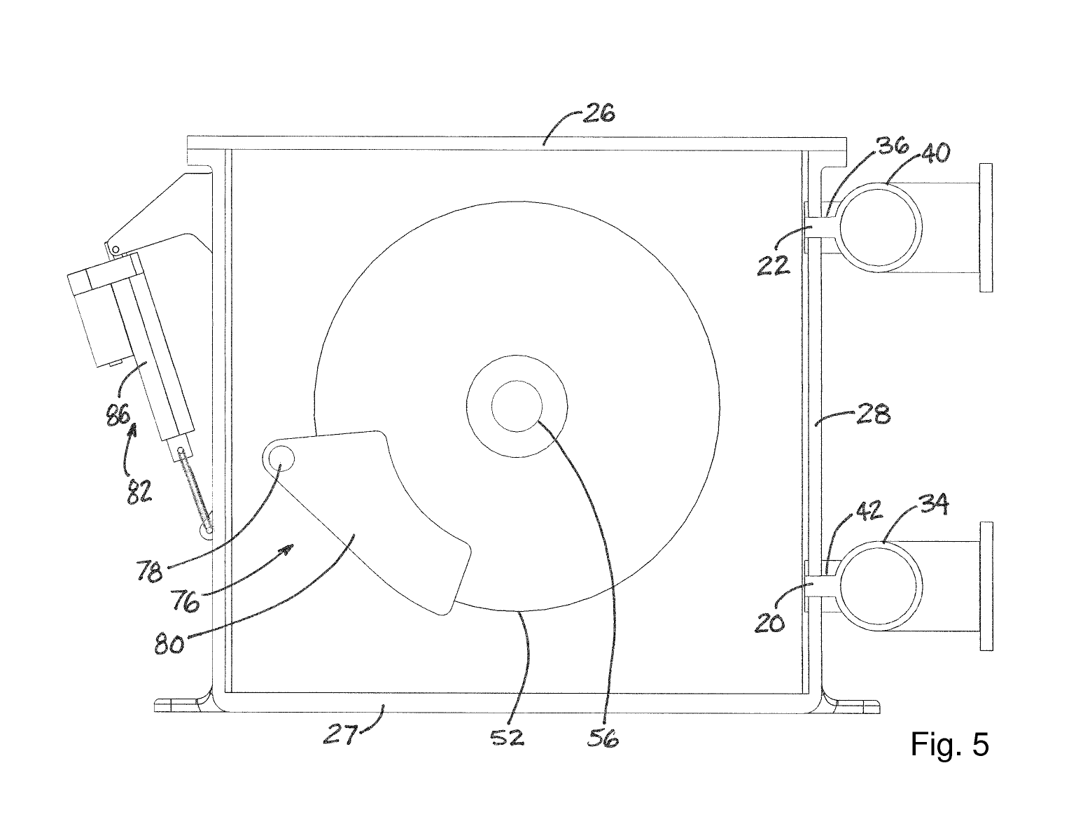

With reference now to the drawings, and in particular to FIGS. 1 through 5 thereof, a new magnetic fluid heating apparatus embodying the principles and concepts of the disclosed subject matter will be described.

The disclosure relates to an apparatus 10 for heating fluid, and is highly suitable for use with an energy source providing rotational movement that comprises, for example, an internal combustion engine or an electric motor. The apparatus 10 may function to heat a flow of fluid as the fluid passes through the apparatus. The apparatus generally receives a flow fluid produced by a pump or other fluid impelling means. The fluid may comprise, for example a liquid substance such as water or a gas substance such as air.

The apparatus 10 may comprise, in a general sense, a housing 12, an fluid heating assembly 14 positioned in the housing, and a magnetic assembly 16 for adjustably inducing heating of a portion of the assembly 14.

In greater detail, the apparatus 10 includes a housing 12 that defines an interior 18 and includes a top wall 26, a bottom wall 27, and a perimeter wall 28. The perimeter wall may include a plurality of wall portions 29. The walls may collectively be liquid tight to contain liquid within the interior. The walls may collectively form a cube, although this is not critical. The housing may also include a fluid inlet 20 and a fluid outlet 22 that are in fluid communication with the interior. For the purposes of this description, the fluid inlet 20 forms the beginning of a fluid path 24 and the fluid outlet 22 forms the end of the fluid path, although it will be understood that the fluid path may continue before and after the inlet 20 and outlet 22. The fluid inlet and fluid outlet may be characterized by an opening formed in the housing 12, and may be located on the same wall portion of the perimeter wall, although this is not critical and positioning on opposite wall portions may be utilized to create a cross flow of fluid through the interior and across the fluid heating assembly. In some embodiments, the fluid inlet 20 may comprise a plurality of fluid inlets. The fluid inlets may be arranged in an array, and in some implementations the array may be linear, and the linear array of inlets may be oriented substantially horizontal. In some embodiments, the fluid outlet 22 may comprise a plurality of fluid outlets. The fluid outlets may also be arranged in an array, and the array may be linear, and the linear array of outlets may be oriented substantially horizontal. In some embodiments, the fluid inlets may be located at a vertical level higher than the fluid outlets.

In embodiments utilizing multiple inlets 20, the apparatus 10 may include an inlet manifold 32 in fluid communication with the fluid inlets, and the inlet manifold may include an inlet tube 34 and a plurality of inlet tube segments 36 connecting the inlet tube to the fluid inlets. Similarly, in embodiments utilizing multiple outlets 22, the apparatus 10 may include an outlet manifold 38 in fluid communication with the fluid outlets, and the outlet manifold may include an outlet tube 40 and a plurality of outlet tube segments 42 connecting the outlet tube to the fluid outlets.

The fluid heating assembly 14 may be positioned in the housing 12, and may be configured to heat the fluid moving through the housing. In the most preferred embodiments, the heating assembly 14 may be rotatable with respect to the housing 12 about an axis of rotation 30. The fluid heating assembly may comprise a support shaft 44 that extends along the axis of rotation 30, and may be supported on bearings mounted on the housing to permit rotation of the shaft with respect to the housing. The support shaft may have a plurality of grooves or splines formed therein, and the grooves may extend axially on the support shaft. The grooved splines may be substantially equally circumferentially spaced about the central section of the shaft, although this is not a critical requirement.

The air heating impeller assembly 14 may also comprise a plurality of annular disks 52 which are positioned along the support shaft 44 and may be spaced from each other in an axial direction to form gaps 54 therebetween. Each of the annular disks 52 has a central aperture 56 which is defined by an aperture edge 58 that may be substantially circular in shape. The support shaft 44 may extend through the central aperture 56 of the disks, and each of the disks may be oriented substantially perpendicular to the axis of rotation 30 of the impeller assembly. The disks 52 are at least partially formed of a conductive material which is susceptible to inductive heating as it passes through a magnetic field. The disks 52 may have one or more notches formed therein which may extend radially outwardly from the central aperture 56, and the notches may engage the grooved splines on the shaft. In some embodiments, such as the illustrative embodiment, the fluid inlet 20 may be positioned to direct fluid toward and through the gaps between the disks, and the plurality of inlets may provide more even distribution of the incoming fluid across the gaps between the disks.

The magnetic assembly 16 may be configured to apply a magnetic field of adjustable intensity to the impeller assembly 14, and more specifically the disks of the assembly. The magnetic assembly 16 may include a plurality of magnetic elements 74 that are positioned adjacent to the disks, and may be positioned in the gaps 54 between the disks. In some of the most preferred embodiments, the magnetic elements are permanent magnets, and may be of rare earth composition. In other embodiments, the magnetic elements 74 may be electromagnetic elements.

The magnetic assembly 16 may further include a support structure 76 supporting the plurality of magnetic elements with respect to the disks 52. The support structure 76 may support the magnetic elements 74 in the gaps 54 between the disks, and may be configured to move the magnetic elements 74 between a maximum exposure position with respect to the conductive material of the disks and a minimum exposure position with respect to the conductive material of the disks. The maximum exposure position may be characterized by the magnetic element 74 being relatively closer to the axis of rotation, and minimum exposure position may be characterized by the element 74 being relatively further away from the axis of rotation. In the maximum exposure position, a relatively greater degree of heating is produced and in the minimum exposure position, a relatively lesser degree of heating is produced.

In some embodiments, the support structure 76 may comprise a pivot shaft 78 that may be pivotally mounted on the housing. The support structure 76 may also comprise a plurality of mounting plates 80 mounted on the pivot shaft and being pivotable with the pivot shaft. At least one of the magnetic elements 74 may be mounted on each of the mounting plates 80, and the mounting plates along with the magnetic elements may be movable toward and away from the axis of rotation. The support structure may further comprise an actuator assembly 82 for pivoting the pivot shaft 78 to adjust the amount of exposure of the disks to the magnetic elements. In some implementations, the actuator assembly 82 may include a pivot arm 84 that is mounted on the pivot shaft 78 in a manner such that the arm pivots with the pivot shaft. The actuator assembly 82 may further include an actuator 86 that acts on the pivot arm to pivot the pivot shaft and move the magnetic elements with respect to the conductive disks. The actuator 86 may be connected to the pivot arm 84 and the housing 12 to cause pivoting of the pivot shaft with respect to the housing. In some implementations, the actuator 86 may comprise a linear actuator, although other actuators, including rotary actuators, may be used to move the pivot shaft.

In some embodiments, the magnetic assembly 16 may maintain a gap of approximately ⅛ inch between the magnetic elements and the surface of the disks, but it will be recognized that the gap may be larger or smaller, with smaller gap sizes enhancing the heating effect on the disks.

Advantageously, the assembly 14 provides heat to the fluid as the fluid moves through the interior of the housing. The magnetic elements are relatively stationary in that they are not a part of the structure that is rotated at high speeds. The disks provide a large surface area for the transfer of heat to the fluid as the fluid is moving through the axial spaces extending between the support shaft and the disks.

While the disks 52 are suitably formed from a flat metal material, the functionality of the disks may be performed by structures that are formed by other means and with other shapes. The disks need not be formed entirely of a conductive (e.g., metal) material, and may be only partially conductive although the inclusion of thermally conductive materials may advantageously increase the thermal mass of the heating assembly for greater heat transfer.

With respect to the above description then, it is to be realized that the optimum dimensional relationships for the parts of the invention, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

I claim:

1. An apparatus for heating a fluid, the apparatus comprising:
a housing defining an interior, the housing having a fluid inlet into the interior and a fluid outlet out of the interior;
a fluid heating assembly positioned in the housing to heat fluid entering the interior, the heating assembly being rotatable with respect to the housing about an axis of rotation, the fluid heating assembly comprising a support shaft and a plurality of disks mounted on the support shaft and being oriented substantially perpendicular to the axis of rotation of the impeller assembly, the plurality of disks being positioned along the support shaft and being spaced from each other in an axial direction to form gaps therebetween, the disks including a conductive material;
a magnetic assembly configured to apply a magnetic field of adjustable intensity to the disks, the magnetic assembly being positioned in the interior of the housing, the magnetic assembly comprising:
a plurality of magnetic elements positioned adjacent to the disks; and
a support structure supporting the plurality of magnetic elements proximate to the gaps between the disks, the support structure moving the magnetic elements between a maximum exposure position with respect to the conductive material of the disks in which a relatively greater degree of heating is produced and a minimum exposure position with respect to the conductive material of the disks in which a relatively lesser degree of heating is produced.

2. The apparatus of claim 1, wherein the support structure comprises:
a pivot shaft pivotable with respect to the housing; and
a plurality of mounting plates having the magnetic elements mounted thereon, the mounting plates being mounted on the pivot shaft and being pivotable with the pivot shaft such that the mounting plates and magnetic elements are movable toward and away from the axis of rotation.

3. The apparatus of claim 2 wherein the support structure further comprises an actuator assembly for pivoting the pivot shaft, the actuator assembly including a pivot arm mounted on the pivot shaft to pivot with the pivot shaft, and an actuator acting on the pivot arm to pivot the pivot shaft.

4. The apparatus of claim 3 wherein the actuator comprises a linear actuator and is located outside of the interior of the housing.

5. The apparatus of claim 1 wherein the fluid inlet comprises a plurality of fluid inlets.

6. The apparatus of claim 5 wherein the plurality of fluid inlets are arranged in a linear array.

7. The apparatus of claim 1 wherein the fluid outlet comprises a plurality of fluid outlets.

8. The apparatus of claim 7 wherein the fluid outlets are arranged in a linear array.

9. The apparatus of claim 8 wherein the fluid inlet comprises a plurality of fluid inlets arranged in a linear array, and the linear array of inlets is oriented substantially parallel to the linear array of outlets.

10. The apparatus of claim 1 wherein the fluid inlet comprises a plurality of fluid inlets and an inlet manifold in fluid communication with the fluid inlets; and
wherein the fluid outlet comprises a plurality of fluid outlets and an outlet manifold in fluid communication with the fluid outlets.
